(19) United States
(12) Patent Application Publication
(10) Pub. No.: US 2010/0123716 A1
(43) Pub. Date: May 20, 2010

(54) Interactive 3D image Display method and Related 3D Display Apparatus

(76) Inventors: Chai-Hsien Li, Taipei Hsien (TW); Pin-Hsien Su, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/425,384

(22) Filed: Apr. 17, 2009

(30) Foreign Application Priority Data
Nov. 19, 2008 (TW) 097144645

(51) Int. Cl. G06T 17/00; G06K 9/00; G06F 3/033

(52) U.S. Cl. 345/420; 382/103; 715/863

(57) ABSTRACT

An interactive 3D image display method for displaying a 3D image of an object, which includes capturing a facial motion image of a user, identifying a corresponding motion instruction according to the facial motion image of the user, rendering a first image and a second image of the object according to the corresponding motion instruction, generating the 3D image of the object according to the first image and the second image, and displaying the 3D image of the object.

### BACKGROUND OF THE INVENTION

1. Field of the Invention

The present invention provides an interactive 3D image display method and related 3D display apparatus, and more particularly, to a method capable of real-time adjustment of the displayed image with user's motion and related 3D display apparatus.

2. Description of the Prior Art

With the rapidly growing display communication technology, a 3D display technology is applied in many areas, such as in a 3D Game or a virtual reality (VR) system. In general, the way to form a 3D image is to provide each eyes of a viewer with two different images representing the same object from two viewpoints, the two different images are then analyzed and overlapped by the brain of the viewer for perceiving depth and gradation of the observed object. Therefore, a 3D display apparatus can display a left eye image for the left eye of the viewer and a right eye image for the right eye of the viewer respectively so that the viewer perceives image content and stereoscopy effect.

However, according to the prior art, as a user changes his view angle, the user may also watches the same 3D image without other 3D image from different view angles. If the user wants to watches the 3D images from different view angle, the 3D display apparatus may have to control the displayed image by a mouse, a keyboard, or other related input devices. For example, in a 3D racing game, as the user wants to watch external appearance of a racing car, the user must select a watching direction, such as up, down, left, right, far, near, etc, via a keyboard. Therefore the user has to use the indirect approach to achieve interactive image, causing the usage inconvenience.

### SUMMARY OF THE INVENTION

It is therefore a primary objective of the claimed invention to provide an interactive 3D image display method and related 3D display apparatus.

The present invention discloses an interactive 3D image display method for displaying a 3D image of an object. The method includes capturing a facial motion image of a user, identifying a corresponding motion instruction according to the facial motion image of the user, rendering a first image and a second image of the object according to the corresponding motion instruction, generating the 3D image of the object according to the first image and the second image, and displaying the 3D image of the object.

The present invention further discloses an interactive 3D image display apparatus for displaying a 3D image of an object. The interactive 3D image display apparatus includes an image capture unit, a motion detection unit, an image processing unit, an image generating unit, and a 3D display module. The image capture unit is utilized for capturing a facial motion image of a user. The motion detection unit is coupled to the image capture unit for identifying a corresponding motion instruction according to the facial motion image of the user. The image processing unit is coupled to the motion detection unit for rendering a first image and a second image of the object according to the corresponding motion instruction. The image generating unit is coupled to the image processing unit for generating the 3D image of the object according to the first image and the second image. The 3D display module is coupled to the image generating unit for displaying the 3D image of the object.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a procedure according to an embodiment of the invention.

FIG. 2(a) is a schematic diagram illustrating relation between a 3D display apparatus and a user according to an embodiment of the invention.

FIG. 2(b) is a schematic diagram of the displayed 3D image corresponding to the condition of FIG. 2(a) according to an embodiment of the invention.

FIG. 3(a) is a schematic diagram illustrating relation between a 3D display apparatus and a user according to another embodiment of the invention.

FIG. 3(b) is a schematic diagram of the displayed 3D image corresponding to the condition of FIG. 3(a) according to an embodiment of the invention.

FIG. 4(a) is a schematic diagram illustrating relation between a 3D display apparatus and a user according to another embodiment of the invention.

FIG. 4(b) is a schematic diagram of the displayed 3D image corresponding to the condition of FIG. 4(a) according to an embodiment of the invention.

FIG. 5 is a schematic diagram of an interactive 3D image display apparatus according to an embodiment of the invention.

### DETAILED DESCRIPTION

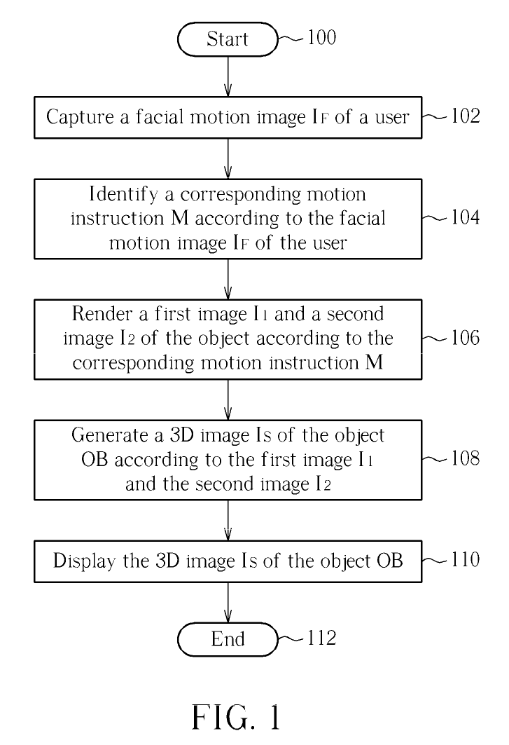

Please refer to FIG. 1. FIG. 1 is a schematic diagram of a procedure 10 according to an embodiment of the invention. The procedure 10 is utilized for displaying a 3D image of an object OB to realize the real-time interactive function between a user and a 3D display apparatus. The procedure 10 comprises the following steps:

Step 100: Start.

Step 102: Capture a facial motion image I_{F} of a user.

Step 104: Identify a corresponding motion instruction M according to the facial motion image I_{F} of the user.

Step 106: Render a first image I₁ and a second image I₂ of the object according to the corresponding motion instruction M.

Step 108: Generate a 3D image I_{S} of the object OB according to the first image I₁ and the second image I₂.

Step 110: Display the 3D image Iₛ of the object OB.

Step 112: End.

According to procedure 10 the invention can capture a facial motion image of a user and identify a corresponding motion instruction M according to the facial motion image of the user. After that, a first image I₁ and a second image I₂ of the object OB are rendered according to the corresponding motion instruction M. Furthermore, a 3D image of the object OB is generated according to the first image and the second image. The 3D image of the object OB is then displayed for the user. In a brief explanation, the invention can generate a corresponding 3D image according to variation of the facial motion image of the user directly and immediately for the user.

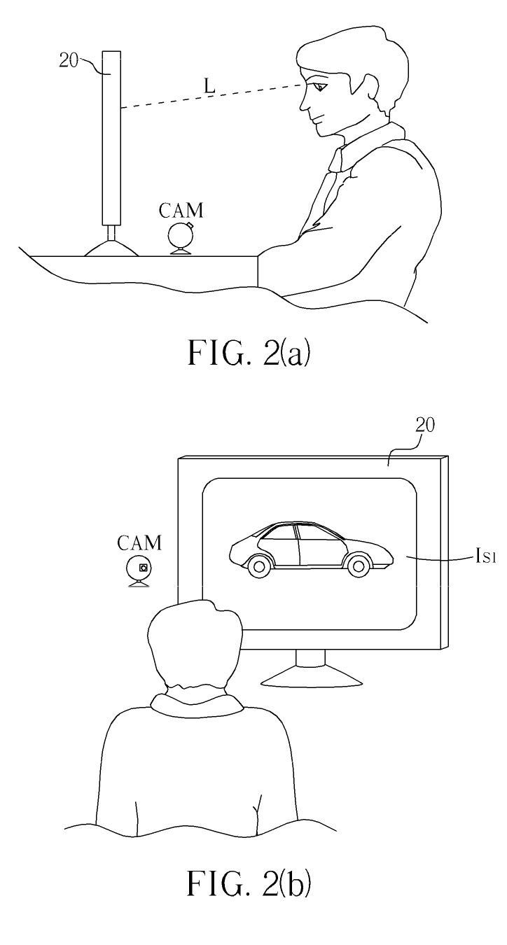

Please refer to FIGS. 2(a) and 2(b). FIG. 2(a) is a schematic diagram illustrating relation between a 3D display apparatus 20 and a user according to an embodiment of the invention. FIG. 2(b) is a schematic diagram of the displayed 3D image corresponding to the condition of FIG. 2(a) according to an embodiment of the invention. As shown in FIG. 2(a), when the user is watching the 3D image along a path L of line-of-sight, a facial motion image I_{F} of the user is captured by an image capture unit CAM. The 3D display apparatus 20 then computes depth variations of the user image according to the facial motion image I_{F} of the user by using a proper algorithm, such as a motion estimation algorithm, in order to identify the facial features image for estimating a corresponding motion. Take the FIG. 2(a) for example, the user is watching the displayed 3D image and didn't have any motion. Therefore, as shown in FIG. 2(b) a first 3D image I_{S1} is displayed for the user.

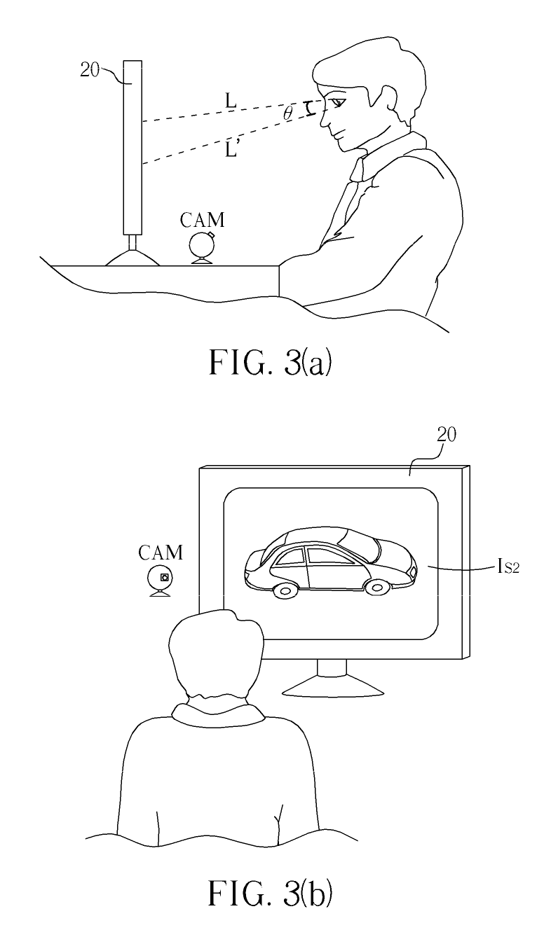

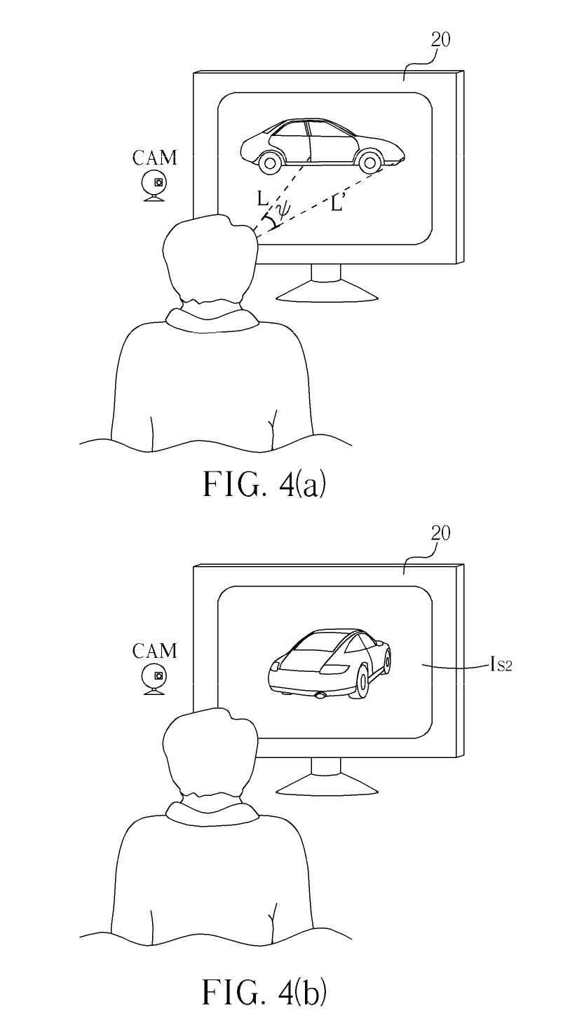

Furthermore, through steps 100 to 104, the 3D display apparatus 20 can generate a corresponding motion instruction M according to the facial motion image I_{F} of the user. Please refer to FIGS. 3(a) and 3(b). FIG. 3(a) is a schematic diagram illustrating relation between a 3D display apparatus 20 and a user according to another embodiment of the invention. FIG. 3(b) is a schematic diagram of the displayed 3D image corresponding to the condition of FIG. 3(a) according to an embodiment of the invention. As shown in FIG. 3(a), the user is watching the 3D image and the path L of line-of-sight is already changed to a path L′, which the angle between L and L′ is θ degrees. Therefore, the 3D display apparatus 20 will detect the path L of line-of-sight has changed θ degrees and then generate a corresponding motion instruction M. In other words, the user wants to watch an image having aerial view of the object OB at the moment. In this way, a first image I₁ and a second image I₂ corresponding to the object OB are rendered according to the motion instruction M so that, the 3D display apparatus 20 changes the first 3D image I_{S1} to a corresponding second 3D image I_{S2} according to the first image I₁ and the second image I₂. That is, the first 3D image I_{S1} with a side view of the object OB is changed to the second 3D image I_{S2} with an aerial view of the object OB. Finally, the second 3D image I_{S2} is displayed. Similarly, please refer to FIGS. 4(a) and 4(b). FIG. 4(a) is a schematic diagram illustrating relation between a 3D display apparatus 20 and a user according to another embodiment of the invention. FIG. 4(b) is a schematic diagram of the displayed 3D image corresponding to the condition of FIG. 4(a) according to an embodiment of the invention. As shown in FIG. 4(a), as the path of line-of-sight is changed from the path L right to a path L′, which the angle between L and L′ being Ψ degrees. Therefore, the 3D display apparatus 20 generates the corresponding second 3D image I_{S2} and displays the second 3D image I_{S2} after identifying the shift motion. As a result, the invention can generate a corresponding 3D image according to variation of the facial motion image of the user directly and immediately, enhancing usage convenience.

Note that, the procedure 10 is an exemplary embodiment of the invention, and those skilled in the art can make alternations and modifications accordingly. For example, in the step 104, preferably, the 3D display apparatus 20 can identify the user's face image and compute variation of relative position of the user's face image according to the facial motion image I_{F} of the user in order to generate the corresponding motion instruction M. In addition, the 3D display apparatus 20 can preferably identify a facial feature image of the user and calculate variation of relative position of the facial feature image according to the facial motion image I_{F} of the user in order to generate the corresponding motion instruction M. Furthermore, in addition to a motion estimation algorithm, any algorithm which can compute depth variations of the user image for identifying facial features image are available. Preferably, facial features can be position of eyes, position of pupils, status of eyelids, and direction of face, which can be utilized for determining variation of relative position of the face or head. For example, while the user is watching the 3D display apparatus 20, the 3D display apparatus 20 can determine variation of viewing angle or distance according to status of the user's pupils and generate a corresponding motion instruction M. Preferably, the motion instruction M can be any motion variation information, such as up, down, right, left, forward, backward, rotation, etc.

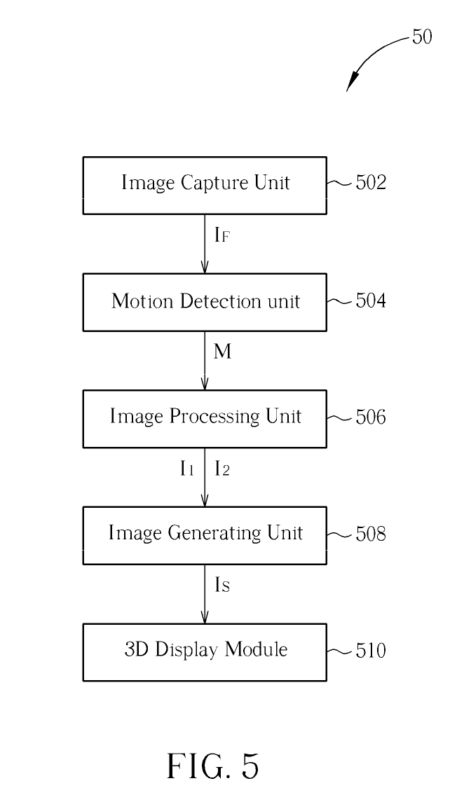

As to the implementation of the procedure 10, please refer to FIG. 5. FIG. 5 is a schematic diagram of an interactive 3D image display apparatus 50 according to an embodiment of the invention. The interactive 3D image display apparatus 50 is utilized for displaying a 3D image of an object OB, which includes an image capture unit 502, a motion detection unit 504, an image processing unit 506, an image generating unit 508, and a 3D display module 510. The image capture unit 502 is utilized for capturing a facial motion image I_{F} of a user. The motion detection unit 504 is coupled to the image capture unit 502 for identifying a corresponding motion instruction M according to the facial motion image I_{F} of the user. The image processing unit 506 is coupled to the motion detection unit 504 for rendering a first image I₁ and a second image I₂ of the object OB according to the corresponding motion instruction M. The image generating unit 508 is coupled to the image processing unit 506 for generating the 3D image I_{S} of the object OB according to the first image I₁ and the second image I₂. The 3D display module 510 is coupled to the image generating unit 508 for displaying the 3D image I_{S} of the object OB.

Therefore, in the interactive 3D image display apparatus 50, the motion detection unit 504 can detect motion status of the user and identify a corresponding motion instruction M, so that the image processing unit 506 is able to render a first image I₁ and a second image I₂ of the object OB according to the corresponding motion instruction M. Then, the image generating unit 508 generates the 3D image I_{S} of the object OB by combining the first image I₁ and the second image I₂ of the object OB. Finally, the 3D image I_{S} of the object OB is displayed by the 3D display module 510. Note that, interactive 3D image display apparatus 50 is an exemplary embodiment of the invention, and those skilled in the art can make alternations and modifications accordingly. For example, the setting location of the abovementioned image capture unit 502 is only an exemplary embodiment, any locations that can capture the motion image of the user is available, and should not be a limitation of the invention. In addition, the image capture unit 502 can transmit the captured image to the motion detection unit 504 through a wireless or wired connection. Any hardware, firmware, or software having processing capability can be implemented as the motion detection unit 504, the image processing unit 506, and the image generating unit 508. Preferably, the first image I₁ and the second image I₂ are the left eye 3D image and the right eye 3D image respectively, and the image generating unit 508 can utilize the first image I₁ and the second image I₂ to generate the 3D image I_{S} after the image processing unit 506 generates the first image I₁ and the second image I₂. Moreover, the 3D display module 510 can be any display module which displays the 3D image correctly.

In summary, the embodiment of the invention can real-time generate a corresponding 3D image for the user according to variation of the facial motion image of the user so as to achieve the interactive function directly and immediately, and enhance usage convenience.

Those skilled in the art will readily observe that numerous modifications and alterations of the device and method may be made while retaining the teachings of the invention.

What is claimed is:

1. An interactive 3D image display method for displaying a 3D image of an object, comprising:
capturing a facial motion image of a user;
identifying a corresponding motion instruction according to the facial motion image of the user;
rendering a first image and a second image of the object according to the corresponding motion instruction;
generating the 3D image of the object according to the first image and the second image; and
displaying the 3D image of the object.

2. The method of claim 1, wherein identifying the corresponding motion instruction according to the facial motion image of the user comprises identifying the user's face image and calculating variation of relative position of the user's face image according to the facial motion image of the user in order to generate the corresponding motion instruction.

3. The method of claim 1, wherein identifying the corresponding motion instruction according to the facial motion image of the user comprises identifying a facial feature image of the user and calculating variation of relative position of the facial feature image of the user according to the facial motion image of the user in order to generate the corresponding motion instruction.

4. The method of claim 3, wherein identifying the corresponding motion instruction according to the facial motion image of the user comprises identifying a pupil position image of the user and calculating variation of relative position of the pupil position image of the user according to the facial motion image of the user in order to generate the corresponding motion instruction.

5. An interactive 3D image display apparatus for displaying a 3D image of an object, comprising:
an image capture unit for capturing a facial motion image of a user;
a motion detection unit coupled to the image capture unit for identifying a corresponding motion instruction according to the facial motion image of the user;
an image processing unit coupled to the motion detection unit for rendering a first image and a second image of the object according to the corresponding motion instruction;
an image generating unit coupled to the image processing unit for generating the 3D image of the object according to the first image and the second image; and
a 3D display module coupled to the image generating unit for displaying the 3D image of the object.

6. The interactive 3D image display apparatus of claim 5, wherein the motion detection unit identifies the user's face image and calculates variation of relative position of the user's face image according to the facial motion image of the user in order to generate the corresponding motion instruction.

7. The interactive 3D image display apparatus of claim 5, wherein the motion detection unit identifies a facial feature image of the user and calculates variation of relative position of the facial feature image according to the facial motion image of the user in order to generate the corresponding motion instruction.

8. The interactive 3D image display apparatus of claim 7, wherein the motion detection unit identifies a pupil position image of the user and calculates variation of relative position of the pupil position image of the user according to the facial motion image of the user in order to generate the corresponding motion instruction.
